(19) United States
(12) Patent Application Publication
(10) Pub. No.: US 2007/0141366 A1
(43) Pub. Date: Jun. 21, 2007

(54) Multilayer film with hot tack property

(76) Inventors: Janet Rivett, Simpsonville, SC (US); Walter B. Mueller, Inman, SC (US)

Correspondence Address: Mark B. Quatt;Sealed Air Corporation, P.O. Box 464, Duncan, SC, 29334, US

(21) Appl. No.: 11/314,374

(22) Filed: Dec. 21, 2005

(51) Int. Cl. B32B 15/04; B32B 27/10; B32B 27/30; B32B 27/32; B32B 27/18

(52) U.S. Cl. 428/457; 428/523; 428/522; 428/537.5; 428/511

(57) ABSTRACT

A multilayer film includes a first layer comprising a blend of a polyolefin, a cyclic olefin copolymer, and polypropylene, and a second layer comprising a polymeric composition having a melting point of less than 130° C. An alternative multilayer film includes a first layer comprising a polyolefin; a second layer comprising a blend of a cyclic olefin copolymer and polypropylene; and a third layer comprising a polymeric composition having a melting point of less than 130° C. A substrate, such as polymeric film, metal, or paper-board, may be bonded to either multilayer film to form a laminate. Methods of triggering a multilayer film are also disclosed, in which the film is subjected to a dosage of actinic radiation effective to trigger the oxygen scavenger in the film.

### FIELD OF THE INVENTION

The invention relates to a multilayer film with hot tack property.

### BACKGROUND OF THE INVENTION

It is known that many oxygen sensitive products, including food products such as meat and cheese, smoked and processed luncheon meats, as well as non-food products such as electronic components, pharmaceuticals, and medical products, deteriorate in the presence of oxygen. These products benefit from the use of oxygen scavengers in their packaging.

One particular oxygen scavenger that has proved useful commercially is poly(ethylene/methyl acrylate/cyclohexene methyl acrylate) (abbreviated as EMCM). Although EMCM containing oxygen scavenging films have excellent cold seal strength, an EMCM layer tends to delaminate from adjacent layers at the temperatures used for heat sealing of the films, generally in the range of 100 to 150° C. These temperatures are typical of those encountered during, or immediately after, heat sealing of the film to itself or another material. Delamination can occur in packaging applications where vertically formed and filled packages are loaded before the heat seals are able to cool substantially. Due to poor interlayer adhesion at these elevated temperatures, the films delaminate at the EMCM interface when a load is placed on the seals before they are totally cooled.

In packaging applications such as vertical form fill seal pouch packaging, where transverse heat seals are used, poor interlaminar bond strength will be manifested as a low hot tack value. The failure mode is typically one of delamination at the interface of the sealant layer and the EMCM layer, and/or the EMCM layer and the next adjacent (internal) layer.

More generally, interlaminar bond failure (delamination) can be an issue at the interface of a first layer, such as a sealant layer, and an adjacent layer comprising a polymer having a melting point of less than 130° C.

### SUMMARY OF THE INVENTION

In a first aspect of the present invention, a multilayer film comprises a first layer comprising a blend of a polyolefin, a cyclic olefin copolymer, and polypropylene; and a second layer comprising a polymeric composition having a melting point of less than 130° C.

In a second aspect of the present invention, a multilayer film comprises a first layer comprising a polyolefin; a second layer comprising a blend of a cyclic olefin copolymer and polypropylene; and a third layer comprising a polymeric composition having a melting point of less than 130° C.

In a third aspect of the present invention, a laminate comprises a multilayer film comprising a first layer comprising a blend of a polyolefin, a cyclic olefin copolymer, and polypropylene, and a second layer comprising a polymeric composition having a melting point of less than 130° C.; and a substrate bonded to the multilayer film.

In a fourth aspect of the present invention, a laminate comprises a multilayer film comprising a first layer comprising a polyolefin, a second layer comprising a blend of a cyclic olefin copolymer and polypropylene, and a third layer comprising a polymeric composition having a melting point of less than 130° C.; and a substrate bonded to the multilayer film.

In a fifth aspect of the present invention, a method of triggering a multilayer film comprises providing a multilayer film comprising a first layer comprising a blend of a polyolefin, a cyclic olefin copolymer, and polypropylene, and a second layer comprising a polymeric composition having a melting point of less than 130° C., wherein the polymeric composition comprises an oxygen scavenger; and subjecting the multilayer film to a dosage of actinic radiation effective to trigger the oxygen scavenger.

In a sixth aspect of the present invention, a method of triggering a multilayer film comprises providing a multilayer film comprising a first layer comprising a polyolefin, a second layer comprising a blend of a cyclic olefin copolymer and polypropylene, and a third layer comprising a polymeric composition having a melting point of less than 130° C., wherein the polymeric composition comprises an oxygen scavenger; and subjecting the multilayer film to a dosage of actinic radiation effective to trigger the oxygen scavenger.

Definitions

“Polyolefin” herein refers to an olefin homopolymer or copolymer, such as ethylene polymer or copolymer, propylene polymer or copolymer, ethylene/alpha olefin copolymer, ethylene/vinyl acetate copolymer, ionomer resin, ethylene/acrylic or methacrylic acid copolymer, ethylene/acrylate or methacrylate copolymer, low density polyethylene, or blends of any of these materials.

“Cyclic olefin” herein means a compound containing a polymerizable carbon-carbon double bond that is either contained within an alicyclic ring, e.g., as in norbornene, or linked to an alicyclic ring, e.g., as in vinyl cyclohexane. Polymerization of the cyclic olefin provides a polymer comprising an alicyclic ring as part of or pendant to the polymer backbone.

“Cyclic olefin copolymer” and the like herein (e.g. “cycloolefin copolymer”) means a copolymer formed by polymerization of a cyclic olefin with a comonomer. An example of a cyclic olefin copolymer is ethylene/norbornene copolymer, such as that supplied by Ticona under the trademark TOPAS™, by Zeon under the trademark ZEONOR™ and by Mitsui under the trademark APEL™.

“Polypropylene” and the like herein means or refers to a propylene homopolymer, or to a copolymer having greater than 50 mole percent propylene. Propylene copolymers are prepared with one or more other comonomers, e.g. ethylene and/or butene comonomers.

“Polymeric composition having a melting point of less than 130° C.” is used herein to refer to either a single polymer having a melting point of less than 130° C., or alternatively a composition of two or more polymers, the composition having a melting point of less than 130° C.

“Ethylene homopolymer or copolymer” herein refers to ethylene homopolymer such as low density polyethylene; ethylene/alpha olefin copolymer such as those defined herein; ethylene/vinyl acetate copolymer; ethylene/alkyl acrylate copolymer; ethylene/(meth)acrylic acid copolymer; or ionomer resin.

“Ethylene/alpha-olefin copolymer” (EAO) herein refers to copolymers of ethylene with one or more comonomers selected from C₃ to C₁₀ alpha-olefins such as propene, butene-1, hexene-1, octene-1, etc. in which the molecules of the copolymers comprise long polymer chains with relatively few side chain branches arising from the alpha-olefin which was reacted with ethylene. This molecular structure is to be contrasted with conventional low or medium density polyethylenes which are more highly branched than their respective counterparts. EAO includes such heterogeneous materials as linear medium density polyethylene (LMDPE), linear low density polyethylene (LLDPE), and very low and ultra low density polyethylene (VLDPE and ULDPE), such as DOWLEX™ or ATTANE™ resins supplied by Dow, and ESCORENE™ resins supplied by Exxon; as well as homogeneous ethylene/alpha olefin copolymers (HEAO) such as TAFMER™ resins supplied by Mitsui Petrochemical Corporation, EXACT™ or EXCEED™ resins supplied by Exxon, or long chain branched (HEAO) AFFINITY™ or ELITE™ resins supplied by the Dow Chemical Company, or ENGAGE™ resins supplied by DuPont Dow Elastomers. Ethylene/alpha-olefin copolymer is made by copolymerization of from about 80 to 99 weight percent ethylene and from 1 to 20 weight percent alpha-olefin. Preferably, the ethylene/alpha-olefin copolymer comprises a copolymer resulting from the copolymerization of from about 85 to 95 weight percent ethylene and from 5 to 15 weight percent alpha-olefin.

“Film” herein means a film, laminate, sheet, web, or the like, which can be used to package a product, such as an oxygen sensitive product. The film can be used as a component in a rigid, semi-rigid, or flexible product, and can be adhered to a polymeric substrate, or to a non-polymeric substrate such as paper or metal. The film can also be used as a coupon or insert within a package.

“Polymer” and the like herein means a homopolymer, but also copolymers thereof, including bispolymers, terpolymers, etc.

“Copolymer” herein refers to a polymer formed by the polymerization reaction of at least two different monomers and is inclusive of random copolymers, block copolymers, graft copolymers, etc.

“Heat shrinkable” herein refers to a property of a film which, when heated to a temperature of 200° F., will exhibit a free shrink (ASTM D 2732-83) of at least 10% in the longitudinal direction, and/or at least 10% in the transverse direction.

“Solid state oriented films” herein refers to films obtained by either coextrusion or extrusion coating of the resins of the different layers to obtain a primary thick sheet or tube (primary tape) that is quickly cooled to a solid state to stop or slow crystallization of the polymers, thereby providing a solid primary film sheet, and then reheating the solid primary film sheet to the so-called orientation temperature (a temperature below the melting point of the film), and thereafter biaxially stretching the reheated film sheet at the orientation temperature using either a tubular solid-state orientation process (for example a trapped bubble method) or using a simultaneous or sequential tenter frame process, and finally rapidly cooling the stretched film to provide a heat shrinkable film. In the trapped bubble solid state orientation process the primary tape is stretched in the transverse direction (TD) by inflation with air pressure to produce a bubble, as well as in the longitudinal direction (LD) by the differential speed between the two sets of nip rolls that contain the bubble. In the tenter frame process the sheet or primary tape is stretched in the longitudinal direction by accelerating the sheet forward, while simultaneously or sequentially stretching in the transverse direction by guiding the heat softened sheet through a diverging geometry frame.

“Oxygen scavenger”, “oxygen scavenging”, and the like herein means or refers to a composition, compound, film, film layer, coating, plastisol, gasket, or the like which can consume, deplete or react with oxygen from a given environment.

“Trigger” and the like herein means that process defined in U.S. Pat. No. 5,211,875, whereby oxygen scavenging is initiated (i.e. activated) by subjecting an article such as a film to actinic radiation having a wavelength of less than about 750 nm at an intensity of at least about 1.6 mW/cm² or ionizing radiation such as an electron beam at a dose of at least 0.2 megarads (MR), or gamma radiation, wherein after initiation the oxygen scavenging rate of the article is at least about 0.05 cc oxygen per day per gram of oxidizable organic compound for at least two days after oxygen scavenging is initiated. A method offering a short “induction period” (the time that elapses, after exposing the oxygen scavenging component to a source of actinic radiation, before the oxygen scavenging activity begins) is useful in situations where the oxygen scavenging component is desirably activated at or immediately prior to use. Triggering can thus occur during filling and sealing of a container, which is made wholly or partly from the article, and which contains an oxygen sensitive material.

Thus, “trigger” refers to subjecting an article to actinic radiation as described above; “triggered” refers to an article that has been subjected to such actinic radiation; “initiation” refers to the point in time at which oxygen scavenging actually begins or is activated; and “induction time” refers to the length of time, if any, between triggering and initiation.

All compositional percentages used herein are presented on a “by weight” basis, unless designated otherwise.

### DETAILED DESCRIPTION OF THE INVENTION

A film of the invention can include multiple layers, dependent upon the properties required of the film. For example, layers to achieve appropriate slip, modulus, oxygen or water vapor barrier, meat adhesion, heat seal, or other chemical or physical properties can optionally be included. The film may be manufactured by a variety of processes including, extrusion, coextrusion, lamination, coating, and the like.

The layer comprising the blend of COC and polypropylene can itself function in one embodiment as a sealant layer. In this embodiment, the layer comprising the blend of COC and polypropylene also comprises a polyolefin. Each of these three materials can be present in any suitable proportion in the layer. For example, the polyolefin can comprise from 40 to 80% by weight of the layer; the COC can comprise from 10% to 30% by weight of the layer, and the polypropylene can comprise from 10% to 30% by weight of the layer.

Examples of combinations of these three materials in the layer include:

PO 70%; COC 20%; PP 10%;

PO 50%; COC 25%; PP 25%;

PO 60%; COC 10%; PP 30%;

PO 70%; COC 15%; PP 15%; and

PO 65%; COC 20%; PP 15%.

The blend of polyolefin, COC and polypropylene can comprise in total any suitable percent by weight of the layer, and can e.g. comprise at least 80%, at least 90%, or 100% of the layer. Other materials, such as antiblock and/or slip additives, or other polymers can be included in the layer.

In an alternative embodiment, a sealant layer distinct from the COC/polypropylene layer can be included in the multilayer film of the invention, and will typically be located adjacent to, and bonded to, the layer comprising the blend of COC and polypropylene. In this embodiment, the blend of COC and polypropylene can be present in any suitable proportion in the blend layer. For example, the COC can comprise from 10% to 90%, 20% to 80%, 30% to 70%, or 40% to 60% by weight of the layer, and the polypropylene can comprise from 90% to 10%, 80% to 20%, 70% to 30%, and 60% to 40% by weight of the layer. The blend of COC and polypropylene can comprise in total any suitable percent by weight of the layer, and can e.g. comprise at least 80%, at least 90%, or 100% of the layer. Other materials, such as antiblock and/or slip additives, or other polymers can be included in the layer.

The layer that will function as a sealant layer of the film, can comprise one or more polymers. Polymers that may be used for the sealant layer include any resin typically used to formulate packaging films with heat seal properties such as various polyolefin copolymers including ethylene polymer or copolymer, ethylene/alpha olefin copolymer, ethylene/vinyl acetate copolymer, ionomer resin, ethylene/acrylic or methacrylic acid copolymer, ethylene/acrylate or methacrylate copolymer, low density polyethylene, or blends of any of these materials.

Additional materials that can be incorporated into the sealant layer of the film include antiblock agents, slip agents, etc.

The layer comprising a polymeric composition having a melting point of less than 130° C. can comprise by way of example EMCM, ethylene/vinyl acetate copolymer (EVA); ethylene/butyl acrylate copolymer (EBA); ethylene/methyl acrylate copolymer; low density polyethylene (LDPE); and linear low density polyethylene (LLDPE) which is an ethylene/alpha olefin copolymer. A typical melting point for EMCM is 69° C. A typical melting point for LDPE and LLDPE is about 125° C.

This layer can have a melting point of less than 100° C., less than 80° C., or less than 70° C. This layer can have a melting point of from 60° C. to 130° C., and from 65° C. to 100° C.

This layer is adjacent to, and bonded to, the layer comprising the blend of polyolefin, COC and polypropylene, or (where a distinct polyolefin sealant layer is present) the layer comprising the blend of COC and polypropylene.

Oxygen Barriers

In some embodiments, high oxygen barrier films can be made in accordance with the invention from materials having an oxygen permeability, of the barrier material, less than 500 cm³ O₂/m²·day·atmosphere (tested at 1 mil thick and at 25° C. according to ASTM D3985), such as less than 100, more preferably less than 50 and most preferably less than 25 cm³ O₂/m²·day·atmosphere such as less than 10, less than 5, and less than 1 cm³ O₂/m²·day·atmosphere. Examples of polymeric materials with low oxygen transmission rates are ethylene/vinyl alcohol copolymer (EVOH), polyvinylidene dichloride (PVDC), vinylidene chloride/methyl acrylate copolymer, polyamide, and polyester.

Alternatively, metal foil or SiOx compounds can be used to provide low oxygen transmission to the container. Metalized foils can include a sputter coating or other application of a metal layer to a polymeric substrate such as high density polyethylene (HDPE), ethylene/vinyl alcohol copolymer (EVOH), polypropylene (PP), polyethylene terephthalate (PET), polyethylene naphthalate (PEN), and polyamide (PA).

Alternatively, oxide coated webs (e.g. aluminum oxide or silicon oxide) can be used to provide low oxygen transmission to the container. Oxide coated foils can include a coating or other application of the oxide, such as alumina or silica, to a polymeric substrate such as high density polyethylene (HDPE), ethylene/vinyl alcohol copolymer (EVOH), polypropylene (PP), polyethylene terephthalate (PET), polyethylene naphthalate (PEN), and polyamide (PA).

Multilayer films of the invention can be made using conventional extrusion, coextrusion, and/or lamination processes. Likewise, conventional manufacturing processes can be used to make a pouch, a bag, or other container from the film.

Hermetic sealing of a pouch, bag, or other container made from the film of the invention will typically be preferable.

In those embodiments of the invention in which the film contains an oxygen scavenger, the exact requirements of a container made from the film will depend on a variety of factors, including the chemical nature of the oxygen scavenger, amount of the oxygen scavenger, concentration of the oxygen scavenger in a host material or diluent, physical configuration of the oxygen scavenger, presence of hermetic sealing, vacuumization and/or modified atmosphere inside the container, initial oxygen concentration inside the container, intended end use of the oxygen scavenger, intended storage time of the container before use, level of initial dose of actinic radiation, etc.

In some embodiments of the invention, a polymeric adhesive can be beneficially used as a tie layer to bond one layer of the film to another layer of the film. Polymeric adhesives that can be used in embodiments of the present invention include e.g. ethylene/vinyl acetate copolymer; anhydride grafted ethylene/vinyl acetate copolymer; anhydride grafted ethylene/alpha olefin copolymer; anhydride grafted polypropylene; anhydride grafted low density polyethylene; ethylene/methyl acrylate copolymer; and anhydride grafted ethylene/methyl acrylate copolymer.

Oxygen Scavengers

Oxygen scavengers suitable for commercial use in articles of the present invention, such as films, include those disclosed in U.S. Pat. No. 5,350,622, and a method of initiating oxygen scavenging generally is disclosed in U.S. Pat. No. 5,211,875. Suitable equipment for initiating oxygen scavenging is disclosed in U.S. Pat. No. 6,287,481 (Luthra et al.). These patents are incorporated herein by reference in their entirety. According to U.S. Pat. No. 5,350,622, oxygen scavengers are made of an ethylenically unsaturated hydrocarbon and transition metal catalyst. The ethylenically unsaturated hydrocarbon may be either substituted or unsubstituted. As defined herein, an unsubstituted ethylenically unsaturated hydrocarbon is any compound that possesses at least one aliphatic carbon-carbon double bond and comprises 100% by weight carbon and hydrogen. A substituted ethylenically unsaturated hydrocarbon is defined herein as an ethylenically unsaturated hydrocarbon which possesses at least one aliphatic carbon-carbon double bond and comprises about 50%-99% by weight carbon and hydrogen. Suitable substituted or un-substituted ethylenically unsaturated hydrocarbons are those having two or more ethylenically unsaturated groups per molecule, e.g. a polymeric compound having three or more ethylenically unsaturated groups and a molecular weight equal to or greater than 1,000 weight average molecular weight.

Examples of unsubstituted ethylenically unsaturated hydrocarbons include, but are not limited to, diene polymers such as polyisoprene, (e.g., trans-polyisoprene) and copolymers thereof, cis and trans 1,4-polybutadiene, 1,2-polybutadienes, (which are defined as those polybutadienes possessing greater than or equal to 50% 1,2 microstructure), and copolymers thereof, such as styrene/butadiene copolymer and styrene/isoprene copolymer. Such hydrocarbons also include polymeric compounds such as polypentenamer, polyoctenamer, and other polymers prepared by cyclic olefin metathesis; diene oligomers such as squalene; and polymers or copolymers with unsaturation derived from dicyclopentadiene, norbornadiene, 5-ethylidene-2-norbornene, 5-vinyl-2-norbornene, 4-vinylcyclohexene, 1,7-octadiene, or other monomers containing more than one carbon-carbon double bond (conjugated or non-conjugated).

Examples of substituted ethylenically unsaturated hydrocarbons include, but are not limited to, those with oxygen-containing moieties, such as esters, carboxylic acids, aldehydes, ethers, ketones, alcohols, peroxides, and/or hydroperoxides. Specific examples of such hydrocarbons include, but are not limited to, condensation polymers such as polyesters derived from monomers containing carbon-carbon double bonds, and unsaturated fatty acids such as oleic, ricinoleic, dehydrated ricinoleic, and linoleic acids and derivatives thereof, e.g. esters. Specific examples also include esters or polyesters of functionalized unsaturated hydrocarbons such as hydroxy terminated polybutadiene. Such hydrocarbons also include polymers or copolymers derived from (meth)allyl(meth)acrylates. Suitable oxygen scavenging polymers can be made by trans-esterification. Such polymers are disclosed in U.S. Pat. No. 5,859,145 (Ching et al.) (Chevron Research and Technology Company), incorporated herein by reference in its entirety. The composition used may also comprise a mixture of two or more of the substituted or unsubstituted ethylenically unsaturated hydrocarbons described above. While a weight average molecular weight of 1,000 or more is beneficial, an ethylenically unsaturated hydrocarbon having a lower molecular weight is also usable, especially if it is blended with a film-forming polymer or blend of polymers.

An additional example of oxygen scavengers which can be used in connection with this invention are disclosed in PCT patent publication WO 99/48963 (Chevron Chemical et al.), incorporated herein by reference in its entirety. These oxygen scavengers include a polymer or oligomer having at least one cyclohexene group or functionality. These oxygen scavengers include a polymer having a polymeric backbone, cyclic olefinic pendent group, and linking group linking the olefinic pendent group to the polymeric backbone.

An oxygen scavenging composition suitable for use with the invention comprises:
(a) a polymer or lower molecular weight material containing substituted cyclohexene functionality according to the following diagram: 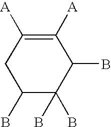
where each A may independently be hydrogen or alkyl and either one or two of the B groups is a linkage which attaches the cyclohexene ring to the polymer backbone or lower molecular weight material, and wherein the remaining B groups are each independently hydrogen or alkyl;
(b) a transition metal catalyst; and
(c) a photoinitiator.

The compositions may be polymeric in nature or they may be lower molecular weight materials. In either case, they may be blended with further polymers or other additives. In the case of low molecular weight materials, they will most likely be compounded with a carrier resin before use.

Also suitable for use in the present invention is the oxygen scavenger of U.S. Pat. No. 6,255,248 (Bansleben et al.), incorporated herein by reference in its entirety, which discloses a copolymer of ethylene and a strained, cyclic alkylene, preferably cyclopentene; and a transition metal catalyst.

Another oxygen scavenger which can be used in connection with this invention is the oxygen scavenger of U.S. Pat. No. 6,214,254 (Gauthier et al.), incorporated herein by reference in its entirety, which discloses ethylene/vinyl aralkyl copolymer and a transition metal catalyst.

Transition Metal Catalysts

As indicated above, the ethylenically unsaturated hydrocarbon can be combined with a transition metal catalyst. Suitable metal catalysts are those that can readily inter-convert between at least two oxidation states.

The catalyst can be in the form of a transition metal salt, with the metal selected from the first, second or third transition series of the Periodic Table. Suitable metals include, but are not limited to, manganese II or III, iron II or III, cobalt II or III, nickel II or III, copper I or II, rhodium II, III or IV, and ruthenium II or III. The oxidation state of the metal when introduced is not necessarily that of the active form. Suitable counterions for the metal include, but are not limited to, chloride, acetate, stearate, palmitate, caprylate, linoleate, tallate, 2-ethylhexanoate, neodecanoate, oleate or naphthenate. Useful salts include cobalt (II) 2-ethylhexanoate, cobalt stearate, and cobalt (II) neodecanoate. The metal salt may also be an ionomer, in which case a polymeric counterion is employed. Such ionomers are well known in the art.

Any of the above-mentioned oxygen scavengers and transition metal catalysts can be further combined with one or more polymeric diluents, such as polymers which are typically used to form film layers in plastic packaging articles. In the manufacture of certain packaging articles well known thermosets can also be used as the polymeric diluent.

Further additives can also be included in the composition to impart properties desired for the particular article being manufactured. Such additives include, but are not necessarily limited to, fillers, pigments, dyestuffs, antioxidants, stabilizers, processing aids, plasticizers, fire retardants, etc.

The mixing of the components listed above can be accomplished by melt blending at a temperature in the range of 50° C. to 300° C. However, alternatives such as the use of a solvent followed by evaporation may also be employed.

Photoinitiators

Photoinitiators that are useful in connection with the oxygen scavengers in this invention include:

1,3,5-tris(4-benzoylphenyl)benzene (BBP³)

isopropylthioxanthone (ITX)

bis(2,4,6-trimethylbenzoyl)phenylphosphineoxide (IRGACURE® 819)

2,4,6-trimethylbenzoyldiphenylphosphine oxide

ethyl-2,4,6-trimethylbenzoylphenyl phosphinate

bis(2,6-dimethoxybenzoyl)-2,4,4-trimethylpentyl phosphine oxide

4,4′-benzoylmethyl diphenyl sulfide (BMS)

The amount of photoinitiator can depend on the amount and type of unsaturation present in the polymer, the wavelength and intensity of radiation used; the nature and amount of antioxidants used; and the type of photoinitiator used.

### EXAMPLES

Several prophetic film structures in accordance with the invention are identified below. “COC” is a cyclic olefin copolymer; “LMP” is a polymeric composition having a melting point of less than 130° C.; “PP” is propylene homopolymer or copolymer; “PO” is olefinic polymer or copolymer e.g. ethylene homopolymer or copolymer, such as low density polyethylene or ethylene/alpha olefin copolymer; “OB” is oxygen barrier; “tie” is an adhesive, such as polymeric adhesive; and “NYLON” is a polyamide or copolyamide.

### Film Structure A

| PO + COC + PP | LMP |
|---|---|
| 0.75 | 1.50 |

### Film Structure B

| PO + COC + PP | LMP + COC |
|---|---|
| 0.75 | 1.50 |

The total gauge of Film Structures A and B is 2.25 mils, with the thickness of each layer, in mils, as indicated above.

### Film Structure C

| PO + COC + PP | LMP | OB |
|---|---|---|
| 0.75 | 1.50 | 0.25 |

### Film Structure D

| PO + COC + PP | LMP + COC | OB |
|---|---|---|
| 0.75 | 1.50 | 0.25 |

The total gauge of each of Film Structures C and D is 2.5 mils, with the thickness of each layer, in mils, as indicated above.

### Film Structure E

| PO + COC + PP | LMP | Tie | OB |
|---|---|---|---|
| 0.75 | 1.50 | 0.25 | 0.25 |

### Film Structure F

| PO + COC + PP | LMP + COC | Tie | OB |
|---|---|---|---|
| 0.75 | 1.50 | 0.25 | 0.25 |

The total gauge of each of Film Structures E and F is 2.75 mils, with the thickness of each layer, in mils, as indicated above.

### Film Structure G

| PO | COC + PP | LMP |
|---|---|---|
| 0.25 | 0.75 | 1.50 |

### Film Structure H

| PO | COC + PP | LMP + COC |
|---|---|---|
| 0.25 | 0.75 | 1.50 |

The total gauge of each of Film Structures G and H is 2.5 mils, with the thickness of each layer, in mils, as indicated above. Where the layer comprising the polymeric composition (of Film Structure H, and other film structures disclosed herein) also includes a COC, these materials can be present in any suitable amount in the layer, provided the melting point of the composition which comprises the layer is less than 130° C.

### Film Structure I

| PO | COC + PP | LMP | OB |
|---|---|---|---|
| 0.25 | 0.75 | 1.50 | 0.25 |

### Film Structure J

| PO | COC + PP | LMP + COC | OB |
|---|---|---|---|
| 0.25 | 0.75 | 1.50 | 0.25 |

The total gauge of each of Film Structures I and J is 2.75 mils, with the thickness of each layer, in mils, as indicated above.

### Film Structure K

| PO | COC + PP | LMP | tie | OB |
|---|---|---|---|---|
| 0.25 | 0.75 | 1.50 | 0.25 | 0.25 |

### Film Structure L

| PO | COC + PP | LMP + COC | tie | OB |
|---|---|---|---|---|
| 0.25 | 0.75 | 1.50 | 0.25 | 0.25 |

The total gauge of each of Film Structures K and L is 3.0 mils, with the thickness of each layer, in mils, as indicated above.

The “tie” layers of Film Structures K and L, and other film structures disclosed herein, can comprise a polymeric adhesive of the type used e.g. in coextrusion of multilayer films. Such adhesives are typically anhydride grafted olefin polymers or copolymers. Alternatively, the tie layers can comprise adhesives of the type used e.g. in lamination of multilayer laminates. Such adhesives are typically polyurethane or like adhesives. The choice of the tie layer composition can be made taking into account the nature of the layers to be adhered together, and the particular methodology for making the film or laminate.

Films comprising PET (poly(ethylene terephthalate) are shown adhered by lamination, such as adhesive lamination, or any other suitable means to the PE (ethylene homopolymer or copolymer) layer of the film (see Film structures M, N, O, and P).

### Film Structure M

| PO + | | | | | | | | |
|---|---|---|---|---|---|---|---|---|
| COC + | | | | | NY- | | | |
| PP | LMP | Tie | NYLON | OB1 | LON | Tie | PE | PET |
| 0.25 | 0.75 | 0.20 | 0.20 | 0.25 | 0.20 | 0.20 | 0.25 | 0.50 |

### Film Structure N

| PO + | | | | | | | | |
|---|---|---|---|---|---|---|---|---|
| COC + | LMP + | | | | NY- | | | |
| PP | COC | tie | NYLON | OB1 | LON | Tie | PE | PET |
| 0.25 | 0.75 | 0.20 | 0.20 | 0.25 | 0.20 | 0.20 | 0.25 | 0.50 |

### Film Structure O

| | COC + | | | NY- | | NY- | | | |
|---|---|---|---|---|---|---|---|---|---|
| PO | PP | LMP | tie | LON | OB1 | LON | Tie | PE | PET |
| 0.25 | 0.25 | 0.75 | 0.20 | 0.20 | 0.25 | 0.20 | 0.20 | 0.25 | 0.50 |

### Film Structure P

| PO | COC + PP | LMP + COC | tie | NYLON | OB1 | NYLON | Tie | PE | PET |
|---|---|---|---|---|---|---|---|---|---|
| 0.25 | 0.25 | 0.75 | 0.20 | 0.20 | 0.25 | 0.20 | 0.20 | 0.25 | 0.50 |

The gauge of each of Film Structures M and N is 2.8 mils, with the thickness of each layer, in mils, as indicated above.

The gauge of each of Film Structures O and P is 3.05 mils, with the thickness of each layer, in mils, as indicated above.

When the polymeric composition having a melting point of less than 130° C. comprises EMCM or another oxygen scavenger intended for scavenging oxygen from the headspace of a package or container, it may be important that the COC/propylene blend layer have a sufficiently high oxygen permeability (oxygen transmission rate) to allow the oxygen from the headspace to move through the film structure to the oxygen scavenger at a sufficient rate to effect the oxygen scavenging functionality of the film. With increasing thickness of the COC containing layer, the presence of increasing amounts of blended polypropylene aids in controlling the overall oxygen transmission rate of the COC+polypropylene layer.

A polyolefin can be included in the COC+polypropylene layer to alter the oxygen transmission rate and/or seal initiation temperature as above, or for any other purpose, and in any suitable amount. Those skilled will understand that tailoring of the formulation of this layer will be guided by the desired end use and physical properties of the final film.

More generally, additional materials, including polymeric materials or other organic or inorganic additives, can be added to any or all of the layers of the above structures as needed, and additional film layers can be included either within the film structure, or adhered to an outer layer thereof.

Film as described herein can be produced by any suitable method, including coextrusion, extrusion coating, lamination, extrusion lamination, etc.

The sealant side of the PE layer of structures K and L, i.e. that side of the layer that will adhere to the PET film, can alternatively be adhered to another polymeric film, to paperboard, or to foil such as metal foil.

Films useful in connection with the invention can have any suitable number of layers, such as a total of from 2 to 20 layers.

In general, the film can have any total thickness desired, and each layer can have any thickness desired, so long as the film provides the desired properties for the particular packaging operation in which the film is used. Typical total thicknesses are from 0.5 mils to 15 mils, such as 1 mil to 12 mils, such as 2 mils to 10 mils, 3 mils to 8 mils, and 4 mils to 6 mils.

In the above film structures, the interface between the oxygen barrier layer and the oxygen scavenger layer will typically include an adhesive or tie layer, such as one of the polyermic adhesives described herein.

The following film structures in accordance with the invention were made by a conventional coextrusion process.

Materials used are given in Table 1.

TABLE 1
Resin Identification

| Material | Tradename Or | |
|---|---|---|
| Code | Designation | Source(s) |
| AB1 | 10853 | Ampacet |
| COC1 | TOPAS ™ 8007 F-04 | Ticona |
| OS1 | OSP500R ™ or DS4713R ™ | Chevron Phillips |
| OSM1 | OSP100M | Chevron Phillips |
| OSB1 | — | — |
| OSB2 | — | — |
| PE1 | AFFINITY PL1850G ™ | Dow |
| PE2 | MARFLEX ™ 4517 | Chevron Phillips |
| PP1 | VISTAMAXX ™ 1100 | ExxonMobil |
| PP2 | ELTEX ™ Peiffer et al. KS 409 | Innovene |
| PP3 | 8473 ™ | Total Petrochemicals |
| PP4 | Z9450 ™ | Total Petrochemicals |
| SL1 | MB50-313 ™ | Dow Corning |
| EMA1 | SP2260 | Voridian |
| PI1 | FIRSTCURE ITX ™ | Albemarle |

AB1 is a masterbatch having about 80% linear low density polyethylene, and about 20% of an antiblocking agent (diatomaceous earth).
COC1 is an ethylene/norbornene copolymer.
OS1 is an oxygen scavenger resin, poly(ethylene/methyl acrylate/cyclohexene methyl acrylate) (abbreviated as EMCM).
OSM1 is a masterbatch produced from a carrier resin (ethylene/methyl acrylate), with 1%, by weight of the masterbatch, of cobalt present in a prill (solid) cobalt oleate, and 1%, by weight of the masterbatch, of tribenzoyl triphenyl benzene (1,3,5-tris(4-benzoylphenyl)benzene).
OSB1 is a blend of 81.1% OS1, 16.7% COC1, and 2.2% OSB2, where each % is by weight of the blend.
OSB2 is a blend of 90% OS1, and 10% of a blend of 90% EMA1 and 10% PI1, where each % is by weight of the blend.
PE1 is a metallocene catalyzed ethylene/1-octene copolymer with a density of 0.902 grams/cubic centimeter, where the octene comonomer forms about 12% by weight of the copolymer.
PE2 is a low density polyethylene resin with a density of about 0.923 grams/cubic centimeter.
PP1 is a single site catalyzed propylene/ethylene copolymer.
PP2 is a single site catalyzed propylene/ethylene copolymer.
PP3 is a Zeigler-Natta catalyzed propylene/ethylene copolymer with about 3.2% ethylene by weight of the copolymer.
PP4 is a single site catalyzed propylene/ethylene copolymer with about 6% ethylene by weight of the copolymer.
SL1 is a polysiloxane masterbatch in an LLDPE carrier resin with a density of 0.94 grams/cc. This material acts as a slip agent.
EMA1 is an ethylene/methyl acrylate copolymer with about 24% methyl acrylate comonomer by weight of the copolymer.
PI1 is a photoinitiator that is an isopropylthioxanthone.

All compositional percentages given herein are by weight, unless indicated otherwise.

Hot tack values are reported in Newtons/inch at the specified temperature, per ASTM F 1921-98, using either a Topwave DTC hot tack tester (method B) or a Theller hot tack tester (method A).

The films of Table 2 were made by conventional coextrusion and adhesive lamination techniques.

TABLE 2
Sealant layer

| | | | | Total |
|---|---|---|---|---|
| Example | Layer 1 | Layer 2 | Layer 3 | Gauge |
| 1 | 58% PE1 + 20% | 90% OSB1 + 10% | PE2 | |
| | COC1 + 10% | OSM1 | | |
| | PP1 + 8% | | | |
| | AB1 + 4% SL1 | | | |
| Layer gauge | 0.25 | 0.75 | 1.50 | 2.5 |
| 2 | 58% PE1 + 20% | 90% OSB1 + 10% | PE2 | |
| | COC1 + 10% | OSM1 | | |
| | PP2 + 8% | | | |
| | AB1 + 4% SL1 | | | |
| Layer gauge | 0.25 | 0.75 | 1.50 | 2.5 |
| 3 | 58% PE1 + 20% | 90% OSB1 + 10% | PE2 | |
| | COC1 + 10% | OSM1 | | |
| | PP3 + 8% | | | |
| | AB1 + 4% SL1 | | | |
| Layer gauge | 0.25 | 0.75 | 1.50 | 2.5 |
| 4 | 58% PE1 + 20% | 90% OSB1 + 10% | PE2 | |
| | COC1 + 10% | OSM1 | | |
| | PP4 + 8% | | | |
| | AB1 + 4% SL1 | | | |
| Layer gauge | 0.25 | 0.75 | 1.50 | 2.5 |

TABLE 3
Hot tack properties

| | Theller | DTC | Theller | DTC |
|---|---|---|---|---|
| Example | 110° C.^{a} | 110° C.^{b} | 135° C.^{c} | 135° C.^{d} |
| 1 | 5.2 | 1.4 | 2.7 | 1.5 |
| 2 | 3.0 | 1.9 | 4.2 | 5.0 |
| 3 | 3.7 | 3.2 | 3.7 | 5.2 |
| 4 | 3.0 | 3.2 | 2.7 | 4.1 |

^{a}Theller test conditions: seal time = 1.5 sec., delay time = 0.25 sec, crosshead speed = 200 cm/min., seal force = 267 psi, seal temperature = 110° C.
^{b}DTC test conditions: seal time = 1.5 sec., delay time = 0.25 sec, crosshead speed = 100 mm/sec., seal force = 68 psi, seal temperature = 110° C.
^{b}Theller test conditions: seal time = 1.5 sec., delay time = 0.25 sec, crosshead speed = 200 cm/min., seal force = 267 psi, seal temperature = 135° C.
^{d}DTC test conditions: seal time = 1.5 sec., delay time = 0.25 sec, crosshead speed = 100 mm/sec., seal force = 68 psi, seal temperature = 135° C.

Hot tack values exhibited by films in accordance with at least some embodiments of the invention, include a hot tack strength, at 110° C., of from 2.5 to 5.5 Newtons/inch, according to ASTM F-1921-98, measured using a Theller hot tack tester; a hot tack strength, at 135° C., of from 2.5 to 4.5 Newtons/inch, according to ASTM F-1921-98, measured using a Theller hot tack tester; a hot tack strength, at 110° C., of from 1.0 to 3.5 Newtons/inch, according to ASTM F-1921-98, measured using a DTC hot tack tester; and a hot tack strength, at 135° C., of from 1.0 to 5.5 Newtons/inch, according to ASTM F-1921-98, measured using a DTC hot tack tester.

Films in accordance with the invention can be used in e.g. vertical form/fill/seal packaging applications, in horizontal form/fill/seal applications, and as lidstock or forming webs. These materials are typically not heat shrinkable and not solid-state oriented. In an alternative embodiment, film in accordance with the invention can be solid-state oriented, and can be rendered heat shrinkable, by well known methods, for applications where an oriented film is desired, or where a heat shrink capability is desired.

The invention is not limited to specific embodiments disclosed herein, and modifications and other embodiments are to be included within the scope of the appended claims. For example, even when a sealant layer distinct from the COC/polypropylene layer is present, the COC/polypropylene layer can comprise other materials, including a polyolefin. As used in the specification and in the claims, the singular form “a,” “an” and “the” include plural referents unless the context dictates otherwise.

What is claimed is:

1. A multilayer film comprising:
a) a first layer comprising a blend of a polyolefin, a cyclic olefin copolymer, and polypropylene, and
b) a second layer comprising a polymeric composition having a melting point of less than 130° C.

2. The multilayer film of claim 1 wherein the first layer is in direct contact with the second layer.

3. The multilayer film of claim 1 wherein the polymeric composition having a melting point of less than 130° C. comprises:
a) an organic oxygen scavenger, and
b) a transition metal catalyst.

4. The multilayer film of claim 1 wherein the polymeric composition having a melting point of less than 130° C. comprises a photoinitiator.

5. The multilayer film of claim 1 wherein the polymeric composition having a melting point of less than 130° C. has a melting point of less than 100° C.

6. The multilayer film of claim 3 wherein the organic oxygen scavenger comprises one or more materials selected from the group consisting of
i) ethylenically unsaturated hydrocarbon,
ii) a polymer having a polymeric backbone, cyclic olefinic pendent group, and linking group linking the olefinic pendent group to the polymeric backbone,
iii) a copolymer of ethylene and a strained, cyclic alkylene, and
iv) ethylene/vinyl aralkyl copolymer.

7. The multilayer film of claim 1 wherein the polymeric composition having a melting point of less than 130° C. comprises one or more materials selected from the group consisting of:
i) ethylene/vinyl acetate copolymer;
ii) ethylene/butyl acrylate copolymer;
iii) ethylene/methyl acrylate copolymer;
iv) low density polyethylene;
v) linear low density polyethylene; and
vi) poly(ethylene/methyl acrylate/cyclohexene methyl acrylate).

8. The multilayer film of claim 1 wherein the average oxygen scavenging rate of the film is at least 25 cc/m²/day for at least two days after the oxygen scavenging property of the film is activated.

9. The multilayer film of claim 1 wherein the second layer comprises a cyclic olefin copolymer.

10. The multilayer film of claim 1 comprising an oxygen barrier layer comprising a polymer having an oxygen transmission rate of no more than 100 cc/m²/24 hr at 25° C., 0% RH, 1 atm (ASTM D 3985).

11. A multilayer film comprising:
a) a first layer comprising a polyolefin;
b) a second layer comprising a blend of a cyclic olefin copolymer and polypropylene; and
c) a third layer comprising a polymeric composition having a melting point of less than 130° C.;
wherein the second layer is disposed between the first layer and the third layer.

12. The multilayer film of claim 11 wherein the first layer is in direct contact with the second layer.

13. The multilayer film of claim 11 wherein the second layer is in direct contact with the third layer.

14. The multilayer film of claim 11 wherein the polymeric composition having a melting point of less than 130° C. comprises:
a) an organic oxygen scavenger, and
b) a transition metal catalyst.

15. The multilayer film of claim 11 wherein the polymeric composition having a melting point of less than 130° C. comprises a photoinitiator.

16. The multilayer film of claim 11 wherein the polymeric composition having a melting point of less than 130° C. has a melting point of less than 100° C.

17. The multilayer film of claim 14 wherein the organic oxygen scavenger comprises one or more materials selected from the group consisting of
i) ethylenically unsaturated hydrocarbon,
ii) a polymer having a polymeric backbone, cyclic olefinic pendent group, and linking group linking the olefinic pendent group to the polymeric backbone,
iii) a copolymer of ethylene and a strained, cyclic alkylene, and
iv) ethylene/vinyl aralkyl copolymer.

18. The multilayer film of claim 11 wherein the polymeric composition having a melting point of less than 130° C. comprises one or more materials selected from the group consisting of:
i) ethylene/vinyl acetate copolymer;
ii) ethylene/butyl acrylate copolymer;
iii) ethylene/methyl acrylate copolymer;
iv) low density polyethylene;
v) linear low density polyethylene; and
vi) poly(ethylene/methyl acrylate/cyclohexene methyl acrylate).

19. The multilayer film of claim 14 wherein the average oxygen scavenging rate of the film is at least 25 cc/m²/day for at least two days after the oxygen scavenging property of the film is activated.

20. The multilayer film of claim 11 wherein the third layer comprises a cyclic olefin copolymer.

21. The multilayer film of claim 11 comprising an oxygen barrier layer comprising a polymer having an oxygen transmission rate of no more than 100 cc/m²/24 hr at 25° C., 0% RH, 1 atm (ASTM D 3985).

22. A laminate comprising:
a) a multilayer film comprising:
i) a first layer comprising a blend of a polyolefin, a cyclic olefin copolymer and polypropylene; and
ii) a second layer comprising a polymeric composition having a melting point of less than 130° C.; and
b) a substrate bonded to the multilayer film;
wherein the substrate comprises a material selected from the group consisting of
i) polymeric film,
ii) metal, and
iii) paperboard.

23. The laminate of claim 22 wherein the polymeric composition having a melting point of less than 130° C. comprises:
a) an organic oxygen scavenger, and
b) a transition metal catalyst.

24. A laminate comprising:
a) a multilayer film comprising:
i) a first layer comprising a polyolefin,
ii) a second layer comprising a blend of a cyclic olefin copolymer and polypropylene;
iii) a third layer comprising a polymeric composition having a melting point of less than 130° C.; and
b) a substrate bonded to the multilayer film;
wherein the substrate comprises a material selected from the group consisting of
i) polymeric film,
ii) metal, and
iii) paperboard.

25. The laminate of claim 24 wherein the polymeric composition having a melting point of less than 130° C. comprises:
a) an organic oxygen scavenger, and
b) a transition metal catalyst.
